(19) United States
(12) Patent Application Publication
(10) Pub. No.: US 2013/0335627 A1
(43) Pub. Date: Dec. 19, 2013

(54) CUSTOMIZATION OF MULTIMEDIA

(71) Applicants: Johan Teodor Larsson, Linkoping (SE); Carl Gustav Cederberg, Linkoping (SE); Carl Victor Ljungstrom, Linkoping (SE); Gustav Salenby, Linkoping (SE); Tomas Taleus, Ljungsbro (SE)

(72) Inventors: Johan Teodor Larsson, Linkoping (SE); Carl Gustav Cederberg, Linkoping (SE); Carl Victor Ljungstrom, Linkoping (SE); Gustav Salenby, Linkoping (SE); Tomas Taleus, Ljungsbro (SE)

(73) Assignee: GENERAL INSTRUMENT CORPORATION, Horsham, PA (US)

(21) Appl. No.: 13/517,627

(22) Filed: Jun. 14, 2012

(51) Int. Cl. H04N 7/01

(52) U.S. Cl. 348/441; 348/E07.003

(57) ABSTRACT

Disclosed are methods and apparatus for processing video content. The method comprises receiving the video content, processing the received video content, and providing, for display on a client device (e.g., a television, computer display, etc.), the processed video content. The processing of the video content uses one or more rules, each of which specifies one or more conditions and one or more actions. Each condition is a criterion for an attribute of the video content. Each action is a transformation of the video content that transforms the values of one or more attributes of the video content. The processing of the video content comprises, for each rule, determining whether the received video content satisfies each of the one or more conditions specified by that rule, and, if it does, performing, on the received video content, each of the actions specified by that rule.

### FIELD OF THE INVENTION

The present invention is related generally to providing customized multimedia content.

### BACKGROUND OF THE INVENTION

Video content may be delivered to consumers in a variety of formats. Typically, providers of video content do not know the aspect ratio, etc., of a device with which the content is displayed by a consumer. Consequently, video content is often delivered to a consumer in a format that is different from that desired by that consumer.

Processes for converting video content into a desired format may be hardcoded into, e.g., a software program running on a consumer's set-top box. However, this technique for automatically converting video content into a format desired by a consumer tends to requires customer-specific code sets. Furthermore, if the consumer were to change his preferences, a new software release may be needed.

Another technique for automatically converting video content into a format desired by a consumer is for the consumer to use a Turing-complete scripting language (e.g., JavaScript) to control the output formatting from the portal application. This is flexible and allows the consumer to control how the content is formatted. However, systems using this technique tend to suffer from relatively poor performance, especially in reacting to new content streams being received. The application of a format change to a new content stream may lag the display of that content to the consumer by several frames.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic illustration (not to scale) showing an example network;

FIG. 2 is a schematic illustration (not to scale) of a set-top box;

FIG. 3 is a process flow chart showing certain steps of an embodiment of the process performed by the set-top box;

FIG. 4 is a schematic illustration (not to scale) showing an example video layer destination transformation; and

FIG. 5 is a schematic illustration (not to scale) showing an example source transformation.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

Embodiments of the invention include methods and apparatus for processing video content. The methods may comprise receiving the video content, processing the received video content, and providing, for display on a client device (e.g., a television, computer display, etc.), the processed video content.

The processing of the video content may use one or more rules, each of which specifies one or more conditions and one or more actions.

Each condition may be a criterion for an attribute of the video content (e.g., aspect ratio, refresh rate, display resolution, color space, size of the window in which the content is to be displayed, etc.). A criterion may be that a particular attribute is within a predefined range or equal to a predefined value.

Each action may be a transformation of the video content that transforms the values of one or more attributes of the video content. An action may change the location on a display at which the video content is to be displayed, or an action may specify a portion of the video content that is to be provided for display. An action may be specified using an appropriate coordinate system.

The processing of the video content may comprise, for each rule, determining whether the received video content satisfies each of the one or more conditions specified by that rule, and, if it does, performing, on the received video content, each of the actions specified by that rule. The rules may be implemented in a predefined order. One or more of the rules may be specified by the user of the client device according to his preferences for displaying video content. Rule sets may be specified using a simple template-based mark-up language, e.g., the rules may be in the form of Extensible Markup Language (XML) formatted files, which tend to avoid cluttering application or portal code with verbose rule specifications. The method may implemented using low-level software routines.

Apparatus for implementing any of the below described arrangements, and for performing the method steps to be described below, may be provided by configuring or adapting any suitable apparatus, for example one or more computers or other processing apparatus or processors, or providing additional modules. The apparatus may comprise a computer, a network of computers, or one or more processors, for implementing instructions and using data, including instructions and data in the form of a computer program or plurality of computer programs stored in or on a machine-readable storage medium such as computer memory, a computer disk, ROM, PROM, etc., or any combination of these or other storage media.

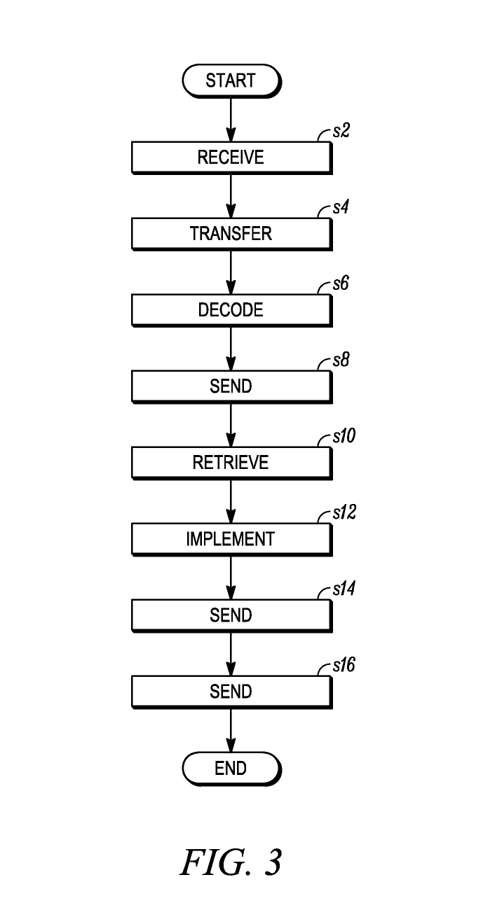

It should be noted that certain of the process steps depicted in the flowchart of FIG. 3 and described below may be omitted or such process steps may be performed in an order differing from that presented below and shown in FIG. 3. Furthermore, although all the process steps have, for convenience and ease of understanding, been depicted as discrete temporally-sequential steps, nevertheless some of the process steps may in fact be performed simultaneously or at least overlapping to some extent temporally.

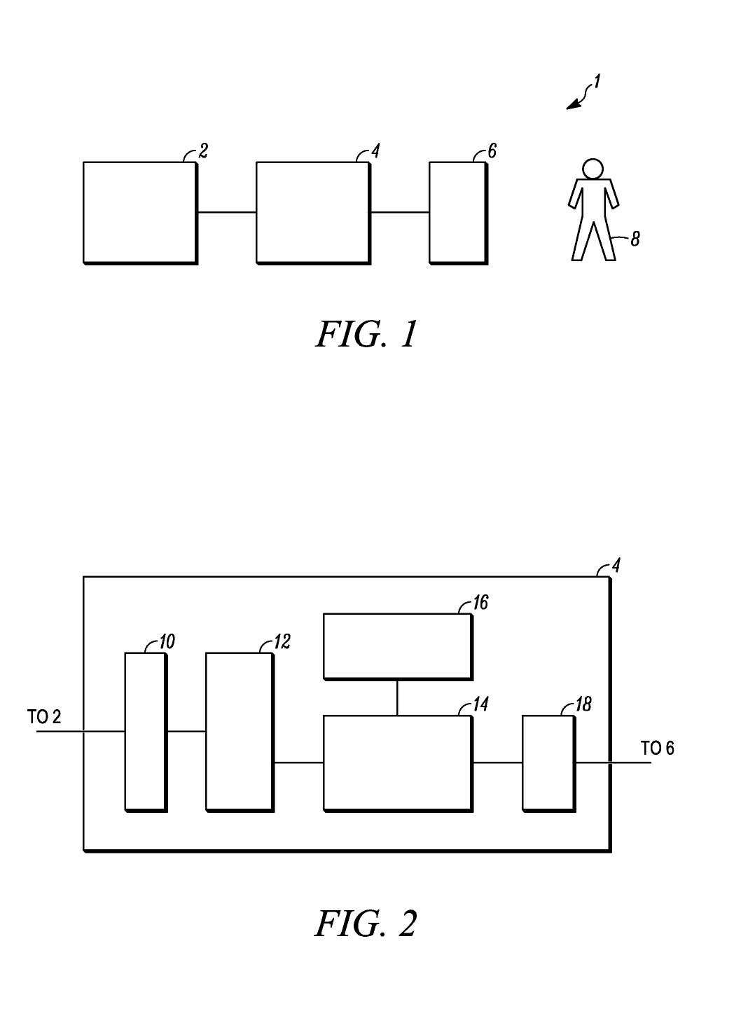

Referring now to the Figures, FIG. 1 is a schematic illustration (not to scale) showing an example network 1 in which an embodiment of a process of converting the format of video content is to be performed. The process of converting the format of video content may be performed in a different appropriate network, e.g., comprising one or more different devices instead of or in addition to those shown in FIG. 1.

The network 1 comprises a content provider 2, a set-top box 4, a television (TV) 6, and a user 8.

The content provider 2 is operatively connected to the set-top box 4.

In operation, the content provider 2 provides video content to the set-top box 4. The video content may be provided from the content provider 2 to the set-top box 4 via a wireless or wired link. The video content may be provided in any appropriate format (e.g., in any appropriate aspect ratio or in any appropriate resolution).

In addition to being operatively connected to the content provider 2, the set-top box 4 is operatively connected to the TV 6. The set-top box 4 is described in more detail below with reference to FIG. 2.

In operation, the set-top box 4 receives video content from the content provider 2. The set-top box 4 processes the received video content using the below described process of converting the format of the video content. The process of converting the format of the video content is described in more detail below with reference to FIG. 3. The video content is processed by the set-top box 4 to convert the format of the video content from the original format (i.e., the format in which the video content was provided by the content provider 2) to a format desired by the user 8. After converting the video content to the format desired by the user 8, the set-top box 4 sends the processed video content to the TV 6.

The TV 6 is a conventional television. In operation, the TV 6 receives the processed video content from the set-top box 4. The TV 6 displays the received video content to the user 8 in the format desired by the user 8.

FIG. 2 is a schematic illustration (not to scale) of the set-top box 4.

The set-top box 4 comprises a receiver 10, a decoding module 12, a processor 14, a rule repository 16, and a transmitter 18.

The receiver 10 is operatively connected to the content provider 2 and to the decoding module 12 such that the receiver 10 receives video content from the content provider 2 and sends the received video content on to the decoding module 12.

The decoding module 12 is configured to decode the received video content so that it can be processed by the processor 14 as described in more detail below with reference to FIG. 3. In addition to being connected to the receiver 10, the decoding module 12 is operatively connected to the processor 14 such that, in operation, decoded video content may be sent from the decoding module 12 to the processor 14.

In addition to being connected to the decoding module 12, the processor 14 is operatively connected to the rule repository 16 and to the transmitter 18.

In operation, the processor 14 processes the decoded video content received by it from the decoding module 12, as described in more detail below with reference to FIG. 3. To process the decoded video content, the processor uses rules (i.e., a rules set) stored in the rule repository 16. Processing of the decoded video content by the processor 14 produces video content in a format desired by the user 8. The video content that is in a format desired by the user 8 is sent from the processor 14 to the transmitter 18.

The transmitter 18 transmits the video content that is in a format desired by the user 8 to the TV 6.

FIG. 3 is a process flow chart showing certain steps of an embodiment of the process by which the set-top box 4 converts the format of video content from the original format (i.e., the format in which the video content was provided by the content provider 2) to a format desired by the user 8.

At step s2, the receiver 10 receives the video content from the content provider 2. The video content may be received by the receiver 10 in encoded form (i.e., the video content may have been encoded, e.g., by the content provider 2 prior to being sent to the set-top box 4).

At step s4, the received video content is transferred from the receiver 10 to the decoding module 12.

At step s6, the video content is decoded by the decoding module 12. The decoded video content may be in any appropriate format having any appropriate attributes (e.g., any appropriate values for the aspect ratio, refresh rate, display resolution, color space, window size, etc). For example, the decoded video content may have an aspect ratio of 4:3.

At step s8, the decoded video content is sent from the decoding module 12 to the processor 14.

At step s10, the processor 14 retrieves the rule set stored in the rules repository 16.

The set of rules comprises one or more rules. Each rule comprises one or more “conditions.” Each rule further comprises one or more “actions.” The conditions of a rule may be considered to be assigned to, i.e., matched to, the actions of a rule. The conditions of a rule comprise information used to determine whether or not the actions of that rule are carried out.

Each condition relates to an attribute of video content, for example, aspect ratio, refresh rate, display resolution, color space, size of the window in which the content is to be displayed, etc. Each condition describes one relevant attribute of the decoded video content. A condition may comprise a precise value for an attribute and also may comprise a tolerance range (i.e., delta values). Three example conditions (each condition relating to either content or window) may be:

Condition: Content: AspectRatio=4:3+/− 1/16

Condition: Content: FrameRate=60+/−0

Condition: Window: FullScreen=true

Each action is a transformation for transforming the video content such that a value of one or more of the video content attributes is changed from having one value to having a different value. For example, each action may be a transformation for transforming the video data from one format to another. For example, a rule may comprise the condition that the aspect ratio is 4:3, and the action (matched to that condition) that transforms video content from having 4:3 aspect ratio to having 16:9 aspect ratio. The actions are described in more detail below with reference to step s12 of FIG. 3.

The rules in the rule set are ordered. For example, the first rule in the rule set is the rule that is considered to have the highest priority, whilst the last rule in the rule set is the rule that is considered to have the lowest priority.

Rule sets may be in the form of XML formatted files. This advantageously tends to avoid cluttering application or portal code with verbose rule specifications. The rules may be stored in persistent memory to be read and parsed by the processor 14. Each XML file may contain one or more rule sets, which in turn may contain one or more rules. The relationships between the conditions and actions of the rules in a rule set, as well as the conditions and actions themselves, may be defined by an XML schema. The simple structure of the rule mechanism tends to allow for a mark-up based specification, as opposed to specification being performed using a Turing-complete algorithm. This tends to make authoring of the rules advantageously simple.

At step s12, the processor 14 processes the decoded video content by implementing each of the rules in the retrieved rules set.

The rules of the retrieved rule set are implemented in order. A rule is implemented as follows. Firstly, the processor determines if the conditions of the rule are satisfied. For example, if the condition of the rule is that the aspect ratio is 4:3, then the processor 14 determines whether or not the aspect ratio of the decoded video content is 4:3. If the conditions of the rule are not satisfied, then the processor 14 may take no action (for that rule) and move on to implement the next rule in the rule set. However, if the conditions of the rule are satisfied, then the processor 14 performs the actions of that rule. For example, if a rule comprises a condition that the aspect ratio is 4:3 and an action that transforms video content from having 4:3 aspect ratio to having 16:9 aspect ratio, and if (at step s12) this condition is satisfied (i.e., the processor 14 determines that the decoded video content has 4:3 aspect ratio), then the processor 14 performs the action to transform the decoded video content from having 4:3 aspect ratio to having 16:9 aspect ratio. In other words, when the conditions of a rule are satisfied, then the actions of that rule are performed. Thus, the rules may be thought of as IF-THEN rules, i.e., IF (conditions are satisfied), THEN (perform corresponding actions).

A rule is considered to be “matching” (or “matched to”) the decoded video content if each of its conditions is fulfilled. Any omitted conditions in a rule may be considered irrelevant. For example, if a rule has a single condition, namely “Aspect Ratio=4:3+/− 1/16,” then the dimensions of the video window do not affect whether the condition is satisfied or not.

The matching algorithm iterates over each rule in a rule set starting with the first rule until it finds a match or reaches the end of the set. The Video Control resource then executes the actions of the matching rule, if any, and repeats the process for the next rules set. This process may be performed efficiently by, for example, aggregating the result of the queries for each rule set into one single action to be executed. The actions of a matched rule are applied to the decoded video content.

The actions of the rules may relate to any appropriate transformation of video content or may relate to how that video content is displayed. For example, there may be four categories of actions: (i) video mode changes, (ii) video layer transformations, (iii) setting of the wide screen signal on Vertical Blanking Interval, and (iv) setting of the SCART function select signal.

The video mode changes may be used to change the display of the video content, e.g., the resolution and refresh rate of the display itself.

A video layer transformation may specify a location on the display of the TV 6 at which to display the content (i.e., where to show the video content on the TV screen). Such a video layer transformation may be called a “destination transformation.” For example, a destination transformation may specify that the content is to be displayed in the central portion of the TV screen only or that the video content is to be displayed in the upper-left of the TV screen only. A destination transformation may be expressed, for example, using a coordinate system that uniquely specifies locations on the TV screen. Also for example, a destination transformation may follow the pixel aspect ratio. If the destination transform is set to follow the pixel aspect ratio, then the transform may be set to present the content with a correct/maintained aspect ratio.

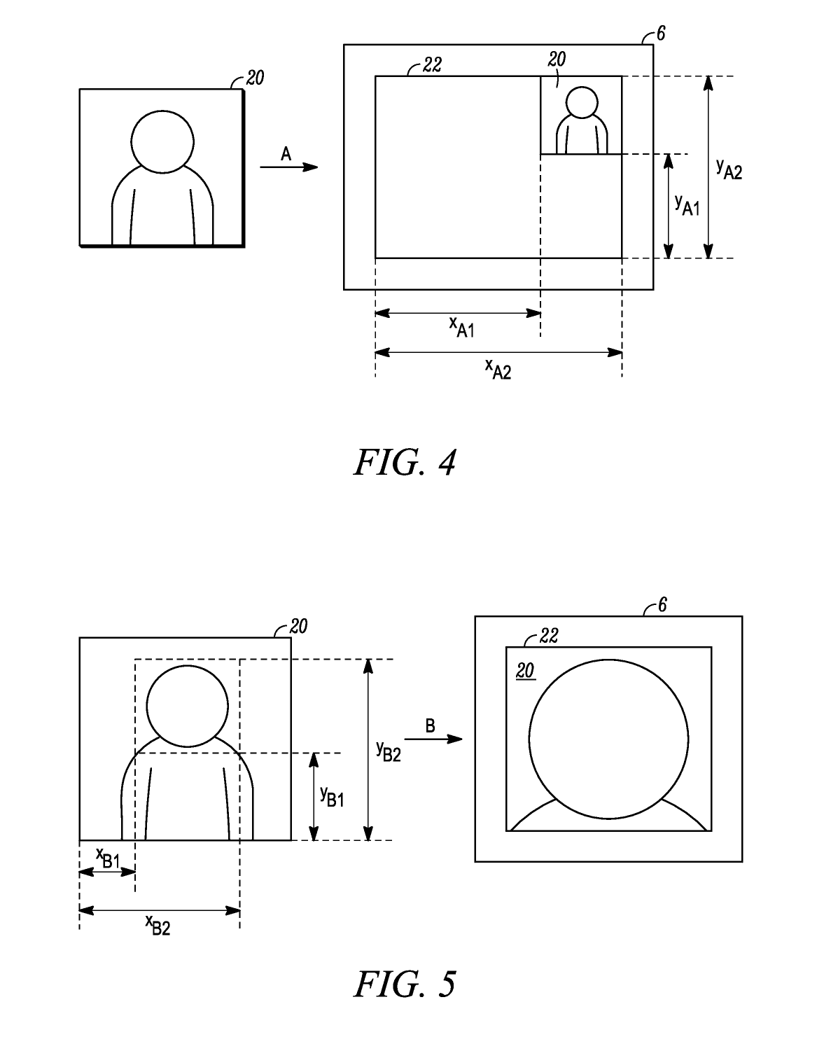

FIG. 4 is a schematic illustration (not to scale) showing an example video layer destination transformation. The video content 20 is transformed by the destination transformation action A such that the content 20 is displayed in the right-hand corner of the screen 22 of the TV 6. The location of the displayed content 20 on the TV screen 22 is uniquely expressed using a coordinate system, e.g., action A specifies the coordinates on the screen 22 for the corners of the video content 20 (xA1, yA1), (xA1, yA2), (xA2, yA1), (xA2, yA2).

A video layer transformation may specify a portion of the video content 20 that is to be displayed on the TV screen 22. Such a video layer transformation may be called a “source transformation.” For example, a source transformation may specify that only the central portion of the video content 20 is to be displayed. A source transformation may be, for example, expressed using a coordinate system that uniquely specifies which part of the video content is to be displayed. Also for example, a source transformation may follow the display extension. If a source transformation is expressed as a rectangle transformation (e.g., using the coordinate system), then the source transform may include additional variables which allow for pixel-dependent adjustments such as overscan removal. If a source transformation is set to follow the display extension, then the source transform may be set in accordance with a display extension coded in the stream.

FIG. 5 is a schematic illustration (not to scale) showing an example source transformation. The video content 20 is transformed by the source transformation action B such that a central portion of the content 20 is displayed on the screen 22 of the TV 6. The central portion of the video content is uniquely expressed using a coordinate system, e.g., action B specifies the coordinates of the corners of the portion of the video content 20 to be extracted (xB1, yB1), (xB1, yB2), (xB2, yB1), (xB2, yB2).

At step s14, the processor 14 sends the processed video content to the transmitter 18.

At step s16, the transmitter 18 transmits the processed video content (i.e., the video content that is in the format desired by the user 8) to the TV 6.

Thus, a process by which the set-top box 4 converts the video content to a format desired by the user 8 is provided.

The above described process may be performed in any appropriate way. For example, the above described process may be implemented using two separate components. A first of these components may be responsible for detecting stream and window conditions, matching rules, and applying actions from matched rules. These operations may advantageously be performed continuously during normal runtime operation. The second component may read rule sets from a file and feed them to the first component (i.e., the second component may be configured to parse information). This, for example, may be performed when booting the system or in direct response to a user action.

Implementing the operative parts of the above described system and method advantageously tends to improve performance and avoid synchronization problems.

The provision of a dedicated condition-action rule system advantageously tends to improve flexibility. For example, one or more of the conditions of a rule may easily be changed as desired. Also, one or more of the actions associated with those conditions may easily be changed as desired. Furthermore, rule sets may easily be re-ordered as desired.

A further advantage provided by the above described system and method is that a user (e.g., the user 8) may easily write his own rules and rule sets or modify an existing rule set according to his preferences. This enables a user to configure how received video content is displayed to him. Thus, a user may customize the system according to his preferences. Users may specify their own rules in any appropriate way, e.g., from a portal or by retrieving appropriate rules from a library.

For example, the TV 6 of the user 8 has a screen 22 that has an aspect ratio of 16:9. The user 8 wants any video content with an aspect ratio of 4:3 to keep the original aspect ratio (i.e., the user 8 does not want any “stretching” of the video content to be performed). Also, the user 8 wants the screen 22 to switch to 1080i when viewing any content in full screen mode, while reverting to a default video mode otherwise. The user 8 may achieve this using the above described system and method, and using, e.g., two rules. A first rule may comprise one single condition and one single action. The condition of the first rule may be that the content aspect ratio is 4:3. The action of the first rule may be a video transform that describes a 4:3 surface on a 16:9 display. A second rule may comprise one single condition and one single action. The condition of the second rule may be that content is viewed in full screen mode. The action of the second rule may be to set the video mode on whatever configurable outputs the set-top box 4 has to 1080i.

In the above embodiments, a single rule set is stored in the rules repository 16 and used, by the processor 14, to process the decoded video content. However, in other embodiments there may be a plurality of rule sets stored in the rule repository 16. The processor 14 may retrieve some or all of these rule sets to be used during the processing of the decided video content. If several rule sets have matching rules, then the actions of those rules may be applied in the order in which the rule sets were retrieved by the processor 14. Thus, if two rule sets have conflicting rules, the rule set which was retrieved last will implicitly have priority over an earlier retrieved rule set. For example, if two rule sets both have matching rules that change the video mode, both actions will be performed in the order that the rule sets were loaded into the processor 14. Since there can be only one video mode on a display, the rule loaded last will override the action of the rule loaded before it.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

1. A method of processing video content, the method comprising:
providing one or more rules, each rule specifying one or more conditions and one or more actions, each condition being a criterion for an attribute of the video content, each action being a transformation of the video content that transforms the video content such that an attribute of the video content is changed from having a first value to having a second value, the second value being different from the first;
receiving the video content;
for each rule, determining whether the received video content satisfies each of the one or more conditions specified by that rule;
for each rule, if it has been determined that the received video content satisfies each of the one or more conditions specified by that rule, performing, on the received video content, each of the actions specified by that rule, thereby providing processed video content; and
providing, for display on a client device, the processed video content.

2. (canceled)

3. A method according to claim 1 wherein the one or more rules are implemented in a predefined order.

4. A method according to claim 1 wherein one or more of the provided rules have been specified by a user of the client device.

5. A method according to claim 1 wherein the one or more rules are specified using an Extensible Markup Language schema.

6.-12. (canceled)

13. Apparatus for processing video content, the apparatus comprising:
a receiver configured to receive the video content;
one or more processors operatively coupled to the receiver and configured to:
access one or more provided rules, each rule specifying one or more conditions and one or more actions, each condition being a criterion for an attribute of the video content, each action being a transformation of the video content that transforms the video content such that an attribute of the video content is changed from having a first value to having a second value, the second value being different from the first;
for each rule, determine whether the received video content satisfies each of the one or more conditions specified by that rule; and
for each rule, if it has been determined that the received video content satisfies each of the one or more conditions specified by that rule, perform, on the received video content, each of the actions specified by that rule, thereby providing processed video content; and
a transmitter operatively coupled to the one or more processors and configured to provide, for display on a client device, the processed video content.

14. (canceled)

15. Apparatus according to claim 13 wherein the one or more rules are implemented in a predefined order.

16. Apparatus according to claim 13 wherein one or more of the provided rules have been specified by a user of the client device.

17. Apparatus according to claim 13 wherein the one or more rules are specified using an Extensible Markup Language schema.

18.-20. (canceled)
